(19) United States
(12) Patent Application Publication
(10) Pub. No.: US 2005/0183573 A1
(43) Pub. Date: Aug. 25, 2005

(54) Method for separating gas mixtures

(75) Inventors: Heinz-Joachim Belt, Burgwedel (DE); Michael Pitroff, Hannover (DE); Thomas Schwarze, Lehrte (DE)

Correspondence Address: CROWELL & MORING LLP;INTELLECTUAL PROPERTY GROUP, P.O. BOX 14300, WASHINGTON, DC, 20044-4300, US

(73) Assignee: Solvay Fluor und Derivate GmbH, Hannover (DE)

(21) Appl. No.: 11/041,243

(22) Filed: Jan. 25, 2005

Related U.S. Application Data
(63) Continuation of application No. PCT/EP02/03753, filed on Apr. 11, 2003.

(30) Foreign Application Priority Data
Jun. 25, 2002 (DE) 102 33 898.1

(51) Int. Cl. B01D 53/02

(52) U.S. Cl. 95/131

(57) ABSTRACT

A method for separating gaseous mixtures from underground cables or gas-insulated circuits in which the gaseous mixtures, which contain partially fluorinated and/or perfluorinated hydrocarbons and inert gases, are brought into contact with hydrophobic zeolites in at least one adsorption step so that the fluorinated hydrocarbons are adsorbed.

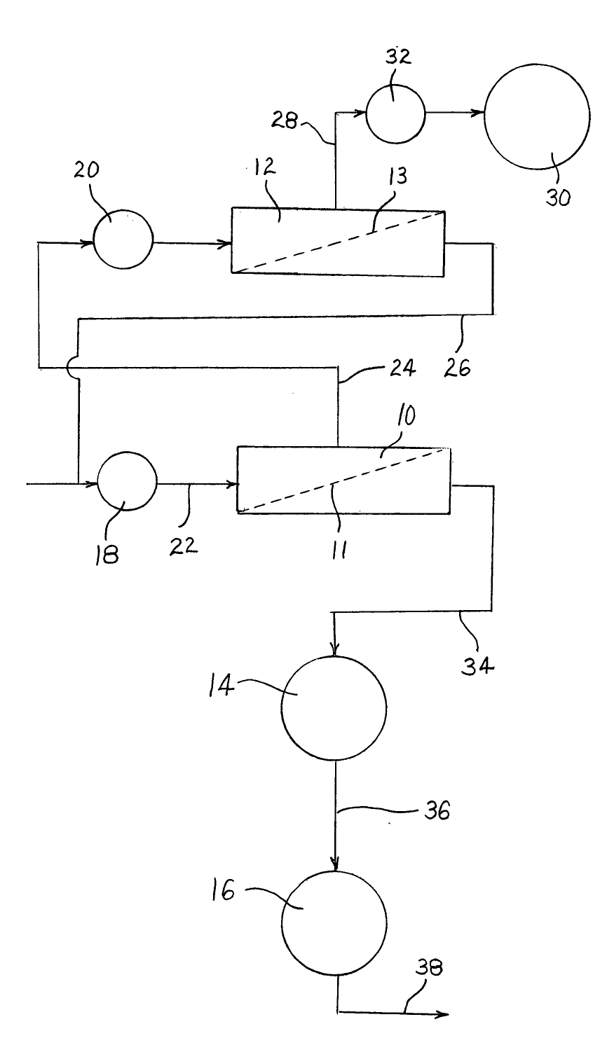

### CROSS REFERENCE TO RELATED APPLICATIONS

This application is a continuation of international patent application no. PCT/EP2003/003753, filed Apr. 11, 2003 designating the United States of America, and published in German as WO 2004/014526 on Feb. 19, 2004, the entire disclosure of which is incorporated herein by reference. Priority is claimed based on Federal Republic of Germany patent application no. DE 102 33 898.1, filed Jul. 25, 2002.

### BACKGROUND OF THE INVENTION

The invention relates to a method for separating gas mixtures, which contain substitute materials for sulfur hexafluoride (SF₆).

Gas mixtures, which contain, for example, sulfur hexafluoride and nitrogen, are used as insulating gases for filling underground cables or circuits (See German utility model 297 20 507.2). Usually, these mixtures contain 5 to 30% by volume of sulfur hexafluoride, the remainder, up to 100%, being nitrogen.

Partially fluorinated and/or perfluorinated hydrocarbons are suitable as substitute materials for sulfur hexafluoride.

It is desirable to reprocess these mixtures after their use with the objective of reusing the partially fluorinated or perfluorinated hydrocarbons. However, there is a problem associated with reprocessing the inert gas portion in the gas mixture which is that it requires a large transporting capacity.

### SUMMARY OF THE INVENTION

It is therefore an object of the present invention to provide an improved method for separating gaseous mixtures.

Another object of the invention is to provide a method for separating gas mixtures which is particularly suited to separating gas mixtures containing partially fluorinated or perfluorinated hydrocarbons.

A further object of the invention is to provide a method for separating gas mixtures which requires only a relatively small transporting capacity to facilitate re-usage of the partially fluorinated and/or perfluorinated hydrocarbons from the mixtures.

An additional object of the invention is to provide an apparatus for carrying out the gaseous mixture separating method of the invention.

In the method according to the invention for separating mixtures of partially fluorinated and/or perfluorinated hydrocarbons on the one hand and inert gases on the other, the mixture is contacted with hydrophobic zeolites with a ratio of silica to alumina (“module”) of at least 80 and a pore diameter of 4 to 20 Å (0.5 to 0.85 nm) and preferably of 6 to 8.5 Å, in order to adsorb the partially fluorinated and/or perfluorinated hydrocarbons. The inert gases, such as nitrogen or the air, which have been separated, can be discharged to the environment.

This simple way of carrying out the method is very suitable for separating gas mixtures, which originate from gas-insulated pipelines or circuits. If these gas mixtures contain additional impurities, such as SO₂F₂, SO₂, etc., they may initially be purified by washing with water or an alkaline solution or by adsorption, for example, by using alumina.

Fluorinated hydrocarbons, which can be liquefied under pressure and are known as sulfur hexafluoride substitutes, are used as partially fluorinated and/or perfluorinated hydrocarbons, which can be separated pursuant to the invention. Preferably, fluorinated hydrocarbons are used which develop a vapor pressure of less than 30 bar (abs.) at 50° C. Suitable representatives of this class of materials include, for example, C₃F₈ (R218), CHF₂CF₃ ((R125), CF₃CHFCF₃ (R227ea), CH₂FCF₃ (R134a), CH₃CH₃ (R143a), CHF₃ (R23), CF₄ (R14), CF₃CF₃ (R116), R404 (R125/R143a/R134a), CF₃OCHF₂ (E125), C₄F₆.

The inert gas components of the mixture may include, for example, nitrogen, carbon dioxide, air and/or noble gases.

Gas mixtures, which, in addition to the partially fluorinated and/or perfluorinated hydrocarbons, also contain sulfur hexafluoride, can also be separated by the method according to the invention.

Incombustibility and the absence of any toxic effect are further criteria for the compounds, which can be used as a substitute for sulfur hexafluoride. These compounds should be gaseous down to a temperature of −25° C. and a pressure of 4 to 8 bar. Examples of particularly suitable compounds which may be used include C₃F₈ and/or CHF₂CF₃.

The method according to the invention comprises at least one adsorption step. Optionally, the gas mixture, which is to be separated, may pass through one or more membrane separation steps for pre-purification before it enters the adsorption step.

### BRIEF DESCRIPTION OF THE DRAWING

The invention will be described in further detail hereinafter with reference to an illustrated preferred embodiment shown in the accompanying drawing FIGURE, which is a schematic depiction of an apparatus according to the invention for carrying out the separating method of the invention.

### DETAILED DESCRIPTION OF PREFERRED EMBODIMENTS

A preferred embodiment for larger amounts of gas mixture is described in the following. This embodiment is a combination of a membrane separation method and adsorption. It is very suitable for mixtures of partially fluorinated and/or perfluorinated hydrocarbons and nitrogen, for example, from underground cables, which have a partially fluorinated and/or perfluorinated hydrocarbon content of 30 to 60% by volume.

Any membrane, which is suitable for the separation of such gas mixtures, can be used in the membrane separation step. The membrane may be present in the usual form. Membranes in the form of a bundle of hollow fibers are very suitable. The membrane material may, for example, be produced from polysulfone, polyetherimide, polypropylene, cellulose acetate, polyimide, polyamide, polyaramide or ethyl cellulose, as described in U.S. Pat. No. 5,730,779. Other membranes, which can be used, include those described in U.S. Pat. No. 4,838,904.

In one embodiment of the method according to the invention, the gas mixture is separated in at least one membrane-separation step into a retentate with an increased content of partially fluorinated and/or perfluorinated hydrocarbons, and a permeate with a decreased content of partially fluorinated and/or perfluorinated hydrocarbons and the permeate is passed on for further separation in at least one adsorption step with the above-described hydrophobic zeolites. Preferably, there are two or more membrane separation steps and two or more adsorption steps.

The pressure at the inlet side of the membrane or membranes usually is higher than ambient pressure. For example, the gas mixture, which is to be separated, can be supplied at a pressure of up to 20 bar. If several membranes are provided, a compressor is disposed before each membrane. Upon entry into the adsorption step, the permeate then usually has a pressure, which corresponds approximately to ambient pressure. If desired, the permeate may be compressed before it enters the adsorption step. However, this is not necessary. Most simply, the permeate is supplied to the adsorption step with the pressure that it has, when it has passed through the membrane. The pressure usually then is up to 4 bar (abs.) and preferably up to 2 bar (abs.).

If there are two membrane separation steps, the gas streams may desirably be handled in the following manner. The mixture, which is to be separated, for example, a mixture of C₃F₈ and nitrogen with 50% by volume of partially fluorinated and perfluorinated hydrocarbons from underground cables, is supplied to the first membrane 11. Since the membrane preferentially permits the passage of nitrogen, a permeate with a high proportion of nitrogen and a low proportion of partially fluorinated and perfluorinated hydrocarbons is obtained. The permeate is passed into the adsorber or into the first adsorber 14. The gas mixture, leaving the first adsorber 14 is then passed into a second adsorber 16 and subsequently, optionally, into a third adsorber, etc. The retentate of the first membrane 11 is passed to a further membrane. The permeate resulting from this second membrane 13 is passed to the first membrane. The retentate from the second membrane 13 contains fluorinated hydrocarbons with small amounts of nitrogen. It can be liquefied with a compressor 32 and then reused immediately or reprocessed to achieve a further increase in the concentration of partially fluorinated and/or perfluorinated hydrocarbons.

The method can be carried out very flexibly with regard to the number of membranes and adsorber steps. One, two or even more adsorber steps are provided depending on the extent to which the partially fluorinated and perfluorinated hydrocarbons are to be concentrated.

Accordingly, the number of membranes depends on whether a gas with a high or a low content of fluorinated hydrocarbons is to be treated. If the number of membranes is larger, the content of partially fluorinated and perfluorinated hydrocarbons in the permeate, which is to be treated adsorptively, is less than if a smaller number of membranes is used. The adsorber may then be constructed smaller or regeneration is necessary only at longer intervals. However, the cost of the equipment can be higher (more compressors).

To regenerate the saturated adsorbents, the pressure is lowered (pressure-change adsorption) and heat is optionally allowed to act on the saturated adsorbents. The partially fluorinated and/or perfluorinated hydrocarbons released can be liquefied by being compressed or cooled. Advantageously, the liquefied gases are filled into steel cylinders, in which they are supplied for a subsequent use.

The method of the invention is distinguished by optimally separating the gas mixture. The purified nitrogen or the purified air can be discharged into the environment without reservations. The method of the invention may advantageously be carried out in a mobile separation apparatus. In this case, the gas mixture, which originates, for example, from underground cables or gas-insulated circuits, can be separated on site.

The apparatus according to the invention for separating gas mixtures comprises one, two or more adsorbers 14, 16 packed with zeolites having a silica to alumina ratio (module) of at least 80 and a pore diameter of 4 to 20 Å (0.4 to 2 nm) and preferably of 5 to 8.5 Å (0.5 to 0.85 nm). A further embodiment has two membrane steps 10, 12 and two adsorber steps 14, 16. A compressor 18, 20 is arranged before each membrane step 10, 12. It furthermore comprises a pipeline 22, connected with the inlet of the first membrane separation step 10, for supplying the gas mixture which is to be separated, a pipeline 24 connecting the first and second membrane separation steps, which is provided for conveying the retentate from the first membrane separation step 10 to the second membrane separation step 12, a connecting pipeline 26 between the second and first membrane separation steps, which is provided for introducing permeate of the second membrane separation step 12 to the first membrane separation step 10, a pipeline 28 for the retentate from the second membrane separation step 12, from which retentate with a high content of partially fluorinated and perfluorinated hydrocarbons can be removed to a collecting vessel 30, a pipeline 34 for supplying the permeate of the first membrane separation step 10 to the first adsorber 14, a pipeline 36 for supplying the gas leaving the first adsorber 14 to the second adsorber 16, and a discharge pipeline 38 from the second adsorber 16 for discharging the separated nitrogen gas or air.

Depending on the capacity of the adsorber and the number of membrane separation steps,.it is also possible to provide only one adsorber step. Two adsorber steps or more are advantageous, since they permit a continuous method of operation, if they are connected in parallel.

The apparatus is preferably in mobile form and set up, for example, on the cargo area of a motor vehicle, such as a truck. The method of the invention can then be carried out on site.

### EXAMPLE

A gas mixture containing approximately 40% by volume of C₃F₈ and 60% by volume of nitrogen, which could correspond to a gas mixture used, for example, in underground cables, was produced by mixing C₃F₈ (R128) and nitrogen. The gas mixture was passed with a pressure of 1 bar (abs.) through a pipeline into an adsorption step. A zeolite of the Pentasil MFI type (Wessalith^{(R)} DAZ F20) with a module of >1,000, a pore width of 0.6 nm and a particle size of 2 mm, was used as adsorber. The nitrogen removed contained only traces of C₃F₈. The adsorber, laden with C₃F₈, was desorbed in a known manner and the recovered C₃F₈ was liquefied under pressure and filled into steel cylinders.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A method for separating a gas mixture containing at least one partially fluorinated or perfluorinated hydrocarbon and at least one inert gas, said method comprising contacting the gas mixture in at least one adsorption step with a hydrophobic zeolite having a silica to alumina ratio of at least 80 and a pore diameter of 4 to 20 Å to adsorb said at least one the partially fluorinated or perfluorinated hydrocarbon.

2. A method according to claim 1, wherein said inert gas comprises at least one gas selected from the group consisting of nitrogen, carbon dioxide, air and noble gases.

3. A method according to claim 1, wherein said hydrophobic zeolite has a pore diameter of 5 to 8.5 Å.

4. A method according to claim 1, wherein said hydrophobic zeolite is finely divided, having a particle size of less than 2 mm.

5. A method according to claim 1, wherein the adsorption is carried out at an absolute pressure of at most 5 bar.

6. A method according to claim 1, wherein said gas mixture comprises from 5 to 95% by volume of said partially fluorinated or perfluorinated hydrocarbons, the remainder up to 100% by volume being inert gases.

7. A method according to claim 6, wherein said gas mixture comprises from 30 to 60% by volume of said partially fluorinated or perfluorinated hydrocarbons.

8. A method according to claim 1, wherein the gas mixture to be separated comprises at least one perfluorinated or partially fluorinated hydrocarbon gas selected from the group consisting of CF₄, CF₃CF₃, C₃F₈, CHF₂CH₃, CF₃CHFCF₃, CH₂FCF₃, CH₃CF₃, CHF₃, C₄F₆, and CF₃OCHF₂.

9. A method according to claim 1, wherein the gas mixture to be separated contains at least one partially fluorinated or perfluorinated hydrocarbon and sulfur hexafluoride.

10. A method according to claim 1, comprising initially separating the mixture to a first membrane separation step to obtain a retentate with an increased content of perfluorinated hydrocarbons and a permeate with a decreased content of perfluorinated hydrocarbons, and thereafter subjecting the permeate to at least one adsorption step by contacting the permeate with hydrophobic zeolite having a silica to alumina ratio of at least 80 and a pore diameter of 4 to 20 Å to adsorb the perfluorinated or partially fluorinated hydrocarbons.

11. A method according to claim 10, wherein the mixture is subjected to at least two membrane separation steps and at least two adsorption steps.

12. A method according to claim 1, wherein the gas mixture is subjected to at least two adsorber steps, and an inert gas is obtained containing less then 10 ppm of said at least one partially fluorinated or perfluorinated hydrocarbon at ambient temperature.

13. A method according to claim 1, wherein said inert gas is nitrogen or air.

14. A method according to claim 1, wherein said gas mixture is an insulating gas mixture collected from an underground cable or a gas-insulated circuit.

15. An apparatus for separating a gas mixture containing at least one partially fluorinated or perfluorinated hydrocarbon and at least one inert gas, said apparatus comprising at least one membrane separator provided with a membrane preferentially permeable to nitrogen, and at least one adsorber containing a hydrophobic zeolite adsorbent having a silica to alumina ratio of at least 80 and a pore diameter of 4 to 20 Å.

16. An apparatus according to claim 15, wherein said apparatus is mobile apparatus mounted on a moveable vehicle.
